(19) United States
(12) Patent Application Publication
(10) Pub. No.: US 2006/0261164 A1
(43) Pub. Date: Nov. 23, 2006

(54) System and Method for Tracking Freight

(75) Inventor: Joseph M. Bochicchio, Charlotte, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Speed Trac Technologies, Inc.

(21) Appl. No.: 11/383,826

(22) Filed: May 17, 2006

Related U.S. Application Data
(63) Continuation-in-part of application No. 11/247,525, filed on Oct. 11, 2005.
Application No. 11/247,525 is a continuation-in-part of application No. 10/425,203, filed on Apr. 28, 2003, now Pat. No. 6,983,883.
(60) Provisional application No. 60/376,248, filed on Apr. 29, 2002.

(51) Int. Cl. G06Q 30/00

(52) U.S. Cl. 235/385

(57) ABSTRACT

The invention provides a system and method that permits information specific to a piece of freight to be encoded onto a label that can be attached to, and travel with, the freight as it moves from a point of origin to its final destination. This “identifying information” encoded on the label can be instantly recalled by scanning the label without the need to recall the information from a central database. As a result, the system helps provide a reliable method of retrieving information about a specific piece of freight in real time and at any point along the shipping route. The system includes a data entry device in which the identifying information is inputted. The inputted information is communicated to an encoding device that encodes the information onto a label, such as a RFID tag or a 2-D bar code. The encoded label is then affixed to the freight.

### CROSS-REFERENCE TO RELATED APPLICATIONS

This application is a continuation-in-part of application Ser. No. 11/247,525 filed Oct. 11, 2005, which in turn, is a continuation-in-part of application Ser. No. 10/425,203 filed Apr. 28, 2003, now U.S. Pat. No. 6,983,883, which in turn, claims priority from U.S. provisional application No. 60/376, 248 filed Apr. 29, 2002, the contents of which are all hereby incorporated by reference in their entirety.

### FIELD OF THE INVENTION

This invention relates to a system and method for tracking freight that is useful in the freight shipment industry.

### BACKGROUND OF THE INVENTION

Typically, in the freight shipment industry, shipments of freight are received from a shipper by the freight carrier, accumulated at freight terminals where they are sorted by shipment destination and then loaded onto tractor-trailer trucks for shipment. At a receiving terminal, the shipments of freight are unloaded, and sorted for trans-shipment or delivery. Usually, the freight shipment is arranged on one or more pallets, and the loading and unloading is handled by lift trucks. Each shipment of freight is assigned an identifying number, and this number is used for tracking the freight from its origin to its destination.

In many cases this identifying number can be used to track the shipment of freight as it moves from the point of origin to its final destination. Traditionally, shipments of freight are accompanied by a shipping document that may include details regarding the freight shipment, such as, point of origin, final destination, shipper, weight, freight classification, and the like. The shipping document can also include the identifying number for the shipment of freight.

Increasingly, it has been more common to include the identifying number with the shipment of freight in the form of a scannable bar code, similar to a universal product code. The scannable bar code can be used to recall and/or transmit information regarding a particular shipment of freight. Typically, the identifying number is retrieved by scanning the bar code into a computer, such as a scanner, that can convert the bar code into the identifying number. The identifying number can then be communicated to a central database in which the identifying number and information associated with the identifying information is stored. The central database is typically maintained by the freight company. The freight company can use the identifying number to store information regarding the shipment of freight such as information that may normally appear on the shipping invoice, last known location of the shipment of freight, and the like.

As noted above, the identifying number and any information associated with the identifying number are generally stored in a database. To recall or upload information regarding the shipment of freight, the identifying number must first be communicated to the database. This may not always be possible. For example, in some circumstances a scanner for reading and communicating with the database may not be readily available. In other circumstances, communication between the scanner and the database may not be possible. This can result in delays in shipping and delivering the shipment of freight because information regarding the delivery address may not be available. In still other circumstances, the database may crash or be otherwise damaged. In such cases, information regarding the shipment of freight may temporarily be non-accessible, or even worse, permanently lost or destroyed. If the information is not available, it may be necessary to retrieve shipping information by manually reviewing paper documents that include details of the shipment. This can result in significant delays and additional labor costs to review the paper documents.

Thus, there still exists a need for a method and system of retrieving information specific to a shipment of freight at any point along its shipping route.

### BRIEF SUMMARY OF THE INVENTION

The present invention provides a system and method that permits information specific to a piece or pieces of freight to be encoded onto a label that can be attached to, and travel with, the piece of freight as it moves from a point of origin, such as a shipper's facility to its final destination. This “identifying information” encoded on the label can be instantly recalled by scanning the label without the need to recall the information from a central database. As a result, the system helps provide a reliable method of retrieving information about a specific piece of freight in real time and at any point along the shipping route.

In one embodiment, the freight carrier provides a vehicle onto which a piece of freight is to be loaded and transported. Upon receiving the shipment of freight, the operator of the vehicle inputs information specific to the shipment of freight into a data entry device. The data entry device communicates the information to an encoding device that encodes the information onto a label. The encoded label is then affixed to the freight. In one embodiment, the encoded label comprises an RFID tag or a 2-D bar code on which a variety of different information can be encoded. The data entry device and the encoding device can be in communication via a wireless communications network. In one embodiment, the encoding device can encode the label with an identification code or number and at least one additional data field selected from the group consisting of: a point of origin; a final destination; weight of the piece of freight, special handling instructions for the piece of freight; classification for the piece of freight; number of items associated with the shipment; estimated value of the piece of freight; and digital image of the piece of freight.

In another embodiment, the system also includes a wireless transmitter that can send and receive information from a remote receiving site, such as the carrier's terminal or central office. In this embodiment, once the vehicle operator has input the identifying information into the data entry device, the identifying information can be transmitted to the remote receiving site. In one embodiment, the wireless transmitter may be configured to communicate using a wide variety of connectivity means, such as a wide area network, land area network, cellular network, or combinations thereof.

In one embodiment, the carrier may use the transmitted identifying information to determine a shipping route and schedule while the freight shipment is still on route to the carrier's terminal from the shipper's facility. Upon reaching the carrier's terminal, the operator of a lift truck may recall this pre-prepared schedule by scanning the encoded label on the piece of freight. In one embodiment, the recalled scheduled may instruct the operator of the lift truck where to move the piece of freight and/or on which truck or loading dock it should be placed. As a result, the amount of time associated with handling freight and preparing shipping routes for shipments of freight may be significantly reduced.

Thus, the present invention provides a system and method that permits information specific to a shipment of freight to be recalled at a remote location by scanning the encoded label affixed to the piece of freight.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic illustration of a system of tracking freight that is in accordance with one aspect of the invention;

FIG. 2 is a graphical illustration of a 2-D bar code;

FIG. 3 is a schematic illustration of a distribution system for shipping freight;

FIG. 4 is a schematic illustration of a data entry device that is in accordance with one embodiment of the invention; and

FIG. 5 is a schematic illustration of an alternative embodiment of a system for tracking freight shipments.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

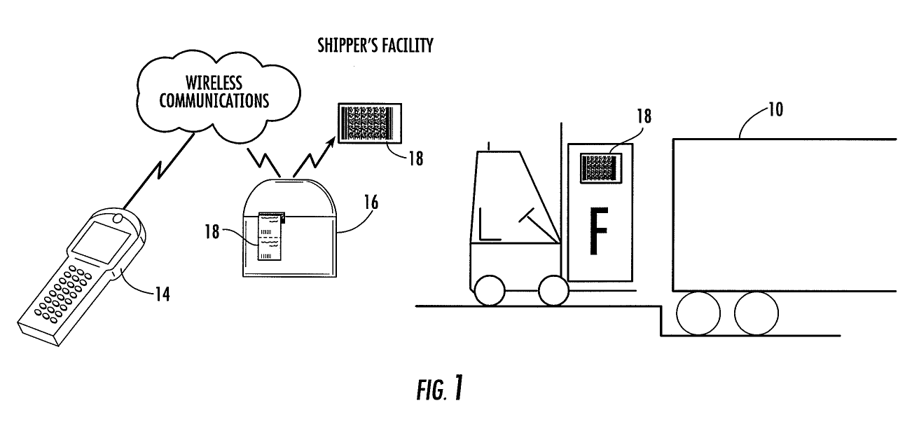

FIG. 1 is a schematic illustration of a system and method of tracking freight that permits real-time retrieval of information associated with a specific piece of freight by scanning an encoded label that is attached to the piece of freight. In one embodiment, as illustrated in FIG. 1, for example, a shipment of freight F is received by the freight carrier at the shipper's loading dock. At the loading dock, the freight carrier provides a vehicle 10, such as a truck, onto which the piece of freight F is to be loaded and transported. Upon receiving the shipment of freight, the operator of the vehicle (e.g., the freight carrier's truck driver) uses a data entry device 14 to input identifying information that is specific to the piece of freight into the data entry device 14.

The data entry device can be configured to receive a wide variety of identifying information that is specific to the piece of freight. In the context of the invention, the term “identifying information” includes information that is associated with a specific piece or pieces of freight. Identifying information may include identification of the shipper, an identification code or number for the shipment of freight, the number of pieces in the shipment, the consignee name and address, the number of pieces in the shipment, estimated value of the freight shipment, description and classification of the shipment, and if applicable, handling instructions, such as an MSDS, stated weight of the shipment of freight, identification of the truck driver, digital image of the freight, date and time, etc. The freight specific information may also include a unique freight bill number, which is often referred to as a “pro number”. The pro number for a shipment of freight may be generated and pre-assigned to a shipment of freight prior to the arrival of the carrier's truck driver at the shipper's facility. Alternatively, the pro number can be generated at the shipper's facility. In one embodiment, the identification code or number for the shipment of freight is the pro number.

The data entry device 14 is configured to communicate the identifying information to an encoding device 16. In one embodiment, the encoding device 16 may be disposed on the carrier's vehicle 10. In another embodiment, the encoding device and the data entry device may be integrated into a single device. The encoding device 16 is operable for receiving the identifying information for a piece of freight from the data entry device and encoding the identifying information onto a label 18. In one embodiment, the encoding device is configured to encode the label with an identification code or number and at least one additional data field selected from the group consisting of: a point of origin; a final destination; weight of the piece of freight, special handling instructions for the piece of freight; classification for the piece of freight; number of items associated with the shipment; estimated value of the piece of freight; and digital image of the piece of freight. The thus encoded label can then be attached to the piece of freight. The label permits the identifying information to travel with the shipment of freight as it moves from the point of origin to its final destination.

After receiving the identifying information, the encoding device can encode it onto a label from which the identity information can be retrieved by scanning the label. In one embodiment, the label includes an adhesive surface that permits it to be affixed to a piece of the freight. The label may be available on a roll comprising a release liner to which a plurality of labels are releasably adhered. In one embodiment, the label comprises a means whereby the identifying information can travel with the freight and be recalled at any point along the freight's shipping route. Preferably, the identifying information is encoded on the label in the form of a machine readable code. In one embodiment, the encoded label comprises an RFID tag, a 2-D bar code, a combination of a 1-D bar code and an RFID tag, and combinations thereof. For example, in some embodiments, the encoding device includes an RF transmitter that is operable for writing the information onto an RFID tag. In other embodiments, the encoding device may comprise a printer that is capable of encoding the information onto the label in the form of a 2-D bar code. In one embodiment, the label comprises a “smart label” wherein an RFID tag is incorporated into a label. In some embodiments, the encoding device may be configured to encode information onto the label using both printing means and RF writing means.

In one embodiment, the label comprises an RFID tag that is capable of storing and transmitting the identifying information. An RFID system typically comprises a transponder, generally referred to as a “tag”, that can receive and send information between the tag and the encoding device or between the tag and a reader, such as a scanner. The RFID tag typically includes a microchip for storing information and an antenna for communicating with a reader and/or writer. After receiving the identifying information from the data entry device, the encoding device can write the information onto the label by sending an RF signal to the RFID tag. The transponder used in an RFID system may be either “passive” or “active.” A passive transponder can be a simple resonant circuit, including an inductive coil and a capacitor. Passive transponders are generally powered by the carrier signal transmitted from the reader or the encoding device. Active transponders, on the other hand, generally include transistors or other active circuitry, and require their own battery source. In one embodiment, the RFID tag may comprise a write once read many tag (WORM), which is configured to be written or programmed once and only once and then read many times throughout the shipment of the freight. In other embodiments, the RFID tag may comprise a writeable tag that is capable of being written and rewritten many times.

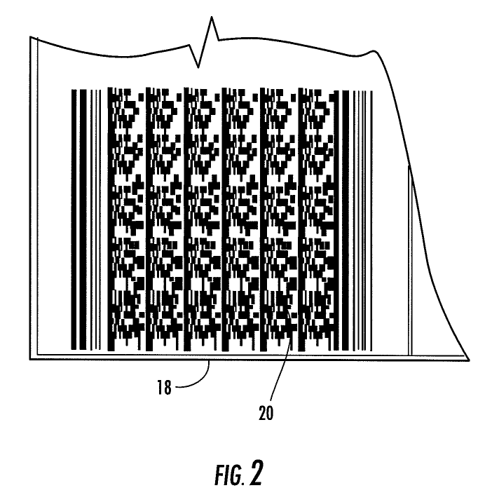

In one embodiment, the identifying information may be encoded onto the label by printing a machine readable code, such as a 2-D bar code onto the label. 2-D barcodes can contain data in both the horizontal and in the vertical axis. A 2-D symbol may be one of two types of machine-readable symbols: a Matrix Symbol or a stacked symbol. In contrast to linear bar codes, such as universal product codes, 2-D barcodes generally include the ability for high data content, small size, data efficiency and error correction capability. 2-D barcode symbologies are able to encode up to several thousand characters of machine readable data. As a result, a 2-D barcode provides the freedom of recalling information that is specific to a particular piece of freight without the need to access an external database. FIG. 2 illustrates an exemplary label 18 having a 2-D bar code 20 that may be used in accordance with the invention. Common types of 2-D barcodes that may be used in the practice of the invention include PDF417, Data Matrix, MaxiCode, and combinations thereof.

Stacked bar codes, such as PDF417, are like a set of linear bar codes literally stacked on top of each other. Stacked barcode symbologies can be read with a variety of readers, such as laser scanners, cameras, or CCDs. Matrix bar codes typically comprise a pattern of cells that can be square, hexagonal, or circular in shape. Matrix symbols can be read by a camera or CCD bar code scanner. Matrix barcodes are typically able to provide higher data densities than stacked codes. Data Matrix and MaxiCode bar codes are the best examples of a matrix code.

In an alternative embodiment, the vehicle operator may be provided with a supply of pre-encoded labels that have been encoded with the identifying information prior to the operator arriving at the shipper's facility. In this embodiment, a shipper may supply the identifying information to the carrier at the time of scheduling the freight shipment. The carrier in turn, would then encode the identifying information onto the label. This may be done at a central location for the carrier or at one of the carrier's terminal facilities. The carrier would then supply the encoded labels to the vehicle operator prior to the operator's departure to the shipper's facility. In one embodiment, the shipper may provide the identifying information to the carrier via an internet portal, such as a website, or by calling the carrier's scheduling department.

In one embodiment, the data entry device is capable of wireless communications with the encoding device. In some embodiments, the data entry device and the encoding device may include one or more input/output (I/O) interfaces. The I/O interfaces may comprise wired or wireless connectivity means such as I2C, ACCESS.bus, RS-232, universal serial bus (USB), IEE-488(GPIB), LAN/Internet protocols such as TCP/IP, wireless means such as infrared (IR) communication, 802.11x, and Bluetooth, etc. In some embodiments, the I/O interface may comprise a combination of wired and wireless connectivity means. In a preferred embodiment, the data entry device and the encoding device may be operably connected to each other via a wireless network, using communications protocols such as Bluetooth.

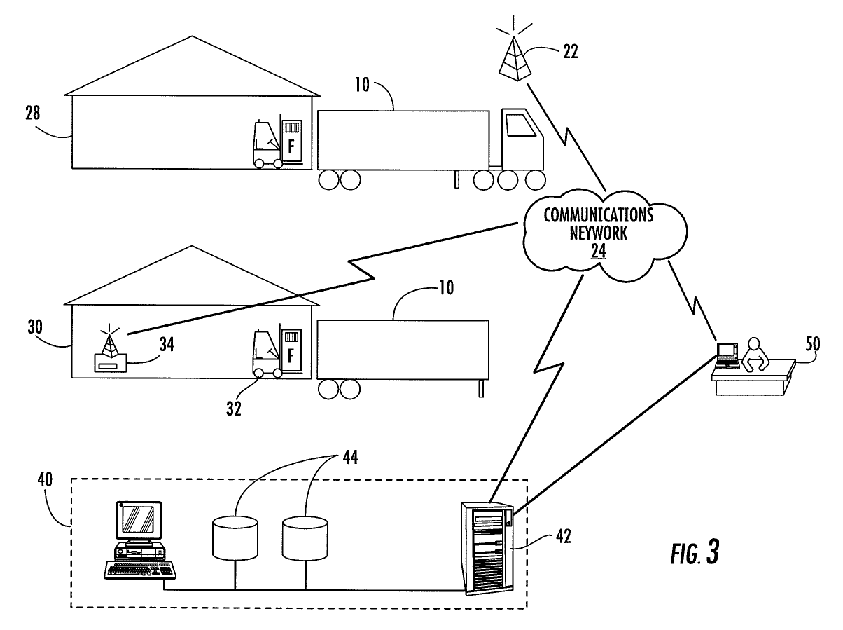

In a further embodiment, the system may also include a wireless transmitter that is capable of communicating the identifying information from the carrier's vehicle, for example while it is still at the shipper's facility, to a remote receiving site. In this regard, FIG. 3 illustrates a freight distribution system wherein the system and method of tracking a shipment of freight includes a wireless transmitter 22 that is operable for communicating information from the carrier's vehicle via a wireless network 24 to a remote receiving site, such as the carrier's terminal facility 30 or the carrier's central office 40. The wireless transmitter may also be operable for receiving and communicating information from the remote receiving site to the carrier's vehicle operator. For example, the wireless transmitter may be configured to receive information from the carrier's dispatcher, such as route scheduling, directions, pick-up locations, etc. As a result, the system permits the carrier facility to instantly update or optimize the vehicle operator's route. The wireless transmitter may be included in one or more of the data entry device, the encoding device, or may comprise a stand-alone device that is disposed on the carrier's vehicle 10, for example. In one embodiment, the wireless transmitter may be capable of wireless communications via a wide area network, local area network, a cellular network, or a combination thereof.

As shown in FIG. 3, a shipment of freight is initially received by the freight carrier at a shipper's facility 28. A label containing identifying information for the freight shipment is generated and applied to the freight shipment as described earlier in connection with FIG. 1. The freight carrier's freight distribution system may include one or more freight terminals 30, which may be located in the same or different cities. While only one freight terminal is depicted for simplicity, it will be understood that a typical freight distribution system may include many freight terminals at various different cities. As shown, the freight distribution system also includes a central office, indicated at 40, where certain business operations of the freight carrier are performed. In one embodiment, the central office may also include a central computer 42 and a database 44 for storing and retrieving identifying information for a particular shipment of freight.

As noted above, the identifying information for a particular shipment of freight can be generated and encoded onto a label by the carrier's vehicle operator when receiving the freight shipment from the shipper or prior to the operator's departure from the carrier's terminal. Upon receiving the shipment of freight, the vehicle operator inputs information regarding the shipment of freight into the data entry device and affixes the encoded label 18 onto the piece of freight at the shipper's facility 28. The wireless transmitter 22 can then communicate the inputted information regarding the shipment of freight to the carrier's central computer 42. The identifying information can be stored in a database 44. In one embodiment, the information regarding the carrier operator's status, route, and the like may also be communicated to the central computer. Alternatively, the identifying information can be communicated to a base computer 34 at the carrier's terminal. The base computer 34 may then communicate the information to the central computer 42.

In one embodiment, the information can also be communicated from the wireless transmitter 22 or the central computer 42 to the carrier's scheduler 50. The scheduler may be located at the carrier's freight terminal or at a central location. The carrier's scheduler can use the thus transmitted information for scheduling available resources for handling the shipment. For example, the central computer system may include a scheduling module which is used by the carrier's scheduling personnel in assigning the freight shipment to an outbound truck having the appropriate destination for the shipment. The scheduler can use the transmitted identifying information to determine a delivery schedule and shipping route for the shipment of freight before the freight reaches the carrier's terminal. As a result, inefficiencies that may be associated with reviewing shipping documents and scheduling shipping routes may be reduced or eliminated. The carrier's dispatcher personnel may also use information for determining the status of the carrier's vehicle operator and redirecting the operator to various shipper's facilities as needed.

In one embodiment, when the carrier's vehicle operator arrives at the carrier's terminal with the thus collected freight shipments, the system and method of the present invention can be used to capture the actual weight of each piece of freight in the shipment. For example, as each piece of freight is handled by a lift truck 32 at the carrier's origin terminal 30, the lift truck operator scans the label for that piece of freight and the weight of the piece of freight can be determined. The lift truck operator may, for example, use a handheld device to read the identifying information encoded on the label that is affixed to a piece of freight. The lift truck operator can also obtain the actual weight of the freight shipment from a weighing device provided on the lift truck. This weight information can be transmitted to a remote computer (not shown) that is disposed on the lift truck or to a terminal computer 34 where it can be associated with the identifying information, such as the identification code or number, and stored. The weight information can also be made available to the central computer 42 in the central office 40.

In another embodiment, the system can also include an unloading module for instructing the forklift operator on where to take the freight. After the encoded label has been scanned from the freight shipment, information from the scheduling module can be transmitted to the forklift operator's device instructing the operator where the freight should be delivered, e.g., to another trailer at the loading dock or to a particular holding and staging area within the terminal facility.

The system can also include a loading module to facilitate loading a trailer with freight. The loading module includes means for receiving information identifying the trailer into which the lift truck loads the piece of freight, and means for associating this trailer identifying information with a maximum load limit for that trailer. Each time a lift truck delivers a piece of freight to that trailer, the accumulated load weight for that trailer is determined by adding the weight of that piece of freight to the weight of all previously loaded pieces of freight. When the accumulated load weight reaches a predetermined level, in relation to the maximum load limit, a signal is generated that can be used to display information to the operator of the lift truck concerning the progress of loading, or alert the operator that the maximum load limit has been reached. The information identifying the trailer into which the piece of freight is loaded can be received in any of several ways. For example, the lift truck operator can use the scanner to scan a trailer identifying bar code located at the entrance to the trailer where the piece of freight is to be loaded. Alternatively, the trailer identification may be preassigned to a piece of freight and associated with the identifying information in the central computer or database. In this case, the scanning of the encode label will serve not only to identify the piece of freight, but can also recall the identity of the trailer into which the piece of freight is to be loaded. Alternatively, the trailer identification can be entered manually into the central computer by the operator of the lift truck using an input device associated with the computer, such as a touch screen, keyboard or pen.

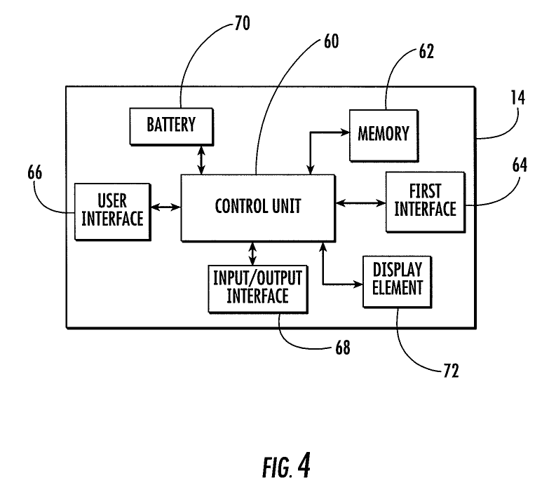

In one embodiment, the data entry device may comprise a handheld device. For example, in one embodiment, data entry device may comprise a portable unit that is configured for wireless communications with the encoding device and a remote receiving facility. With reference to FIG. 4, a schematic illustration of an exemplary data entry device 14 is illustrated. The data entry device may include a control unit 60, a memory component 62, a first interface 64 that may be adapted for wireless communication with the encoding device, a user interface 66, such as a keypad, a second interface 68 adapted for communicating with the remote receiving facility, such as an input/output interface, a power supply such as a battery 70, and a display element 72 that is capable of displaying text messages, menus, and the like. As shown in FIG. 4, the various components of the data entry device, such as the interfaces, processor, memory, display element, and battery are typically operatively connected to one another.

The control unit 60 may comprise a microprocessor or microcontroller configured to perform dedicated functions such as controlling the data entry device and executing program modules that are capable of storing and transmitting the inputted identity information. The microcontroller may also include memory components such as RAM, EEPROM, and PROM, internal timers, and I/O port interfaces. The control unit may include an internal memory component (not shown) that may be an integral part of the control unit. In some embodiments, the control unit may include executable program modules embedded within the internal memory component of the control unit.

The first interface device may comprise an interface that facilitates wireless communication between the data entry device and the encoding device, remote receiving facility, and additional devices in the system. In one embodiment, the first interface comprises an RF communication interface that permits communications between the data entry device and the encoding device via a wireless network using a Bluetooth protocol, for example. In other embodiments, the first interface is a wireless transmitter comprising a cellular network interface that permits communications between the data entry device and the remote receiving facility. As noted above, the wireless transmitter may be capable of wireless communications via a wide area network, land area network, a cellular network, or a combination thereof. In one embodiment, the data entry device may be able to communicate with the encoding device via a wireless RF network using a protocol such as Bluetooth, and communicate with the remote receiving facility using a cellular network. In other embodiments, the data entry device may be configured for wireless communication of both data, such as text data, and audible data, such as telephonic communications.

In some embodiments, the I/O interface may comprise an RF communication interface 68 having an RFID transceiver that is adapted to allow the data entry device to send and/or retrieve data from a label comprising an RF tag. In some embodiments, the RFID communication interface may also be adapted to write or rewrite information onto the RFID tag. The RFID transceiver may perform read only or read-write communications depending on the application. In some embodiments, the data entry device may also include a scanner (not shown) that is capable of reading 2-D bar codes. The ability to read 2-D bar codes with the data entry device may permit the carrier vehicle operator to recall information regarding the freight as needed.

In one embodiment, the data entry device includes an associated memory component 62 that is configured to store identifying information inputted into the data entry device by the vehicle operator. In one embodiment, the associated memory component comprises flash memory. Flash memory refers generally to a type of nonvolatile memory that can be erased and reprogrammed in units of memory called blocks. The capacity of the memory component can be varied depending upon the desired amount of data that can be stored before downloading the data into an external computer or similar device. In some embodiments the capacity of the associated memory component may comprise 64K, 128K, 256K, or 512K memory blocks. In this embodiment, the data entry device may be configured to store identifying information in a memory component and then transmit the stored identifying information to the remote receiving facility or another device at an appropriate time. Alternatively, the stored information can be retained until the vehicle operator returns to the terminal and then downloads the stored information into the terminal's computer system.

The data entry device may also include a display element that is capable of displaying various menu options, inputted information, route scheduling, maps, etc. In one embodiment, the display element may also be capable of displaying information sent to the vehicle operator from the carrier's terminal or central office. For example, in one embodiment, the data entry device can be configured to receive dispatch information transmitted from a central freight terminal about freight shipments requiring pick-up and to display the same to the operator of the vehicle via the display element.

In a further embodiment, the data entry device may also include an optional imaging module for capturing image information about the freight shipment. In one embodiment a digital camera may be incorporated into the data entry device and can be used to capture a digital photograph of the freight shipment. For example, when the components of the data entry device are integrated into a single handheld unit, this handheld unit can also include a digital camera. Imaging data representing a digital photograph of the freight shipment can be transmitted to the central computer along with the other information obtained about the freight shipment. This information can be used by the central office as proof of shipment received, state of the shipment, as well as to enable reviewing the shipment for appropriate product classification. The data entry device used by the carrier's truck driver may also suitably include a global positioning satellite (GPS) transmitter module for transmitting information about the location of the freight pickup truck back to the central office for use by the scheduling module. This will allow the central office to determine when the pickup truck can be expected back at the central office with the freight shipments.

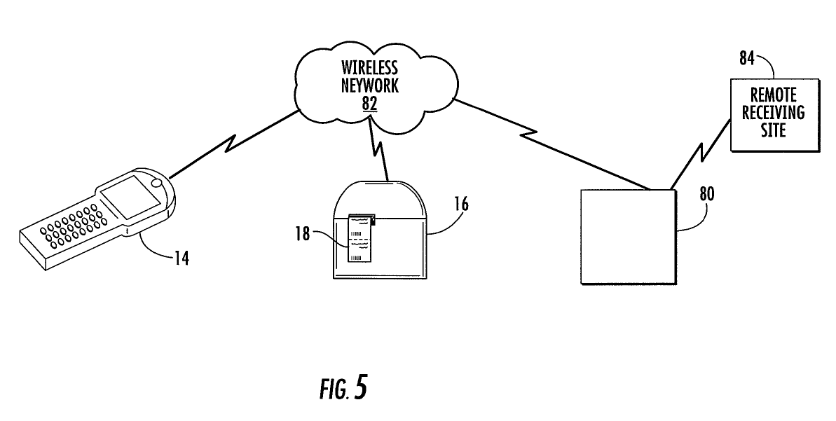

In another embodiment, system may include a stand-alone device, such as an external communications interface, that is disposed on the carrier's vehicle and is capable of communicating with the remote receiving site. In this embodiment, the communications interface can be capable of communicating with the remote receiving site on the data entry device or encoding device. In this regard, FIG. 5 illustrates an embodiment wherein the data entry device 14, encoding device 16, and an external communication interface 80 are in communication via communication network 82. In this embodiment, the communication interface 80 serves as an intermediary between the data entry device or the encoding device and the remote receiving site. The identifying information that is inputted into the data entry device is communicated to the communication interface 80, which in turn, can communicate the information to the remote receiving site 84. In one embodiment the communication interface can also be configured to communicate information from the remote receiving site to the data entry device. Typically, the communication network between the communication interface 80 and the data entry device and/or the encoding device comprises a personal computer network, such as a network that utilizes Bluetooth, whereas communications between the communication interface 80 and the remote receiving site may utilize a wide area network, land area network, cellular network, and the like, and combinations thereof.

In one embodiment, the communications interface may also comprise multi-functional capabilities. For example, the communication interface may include diagnostic capabilities, GPS capabilities, vehicle maintenance diagnostic capabilities, electronic driver logs, storage capabilities, and the like. In one embodiment, the communication interfaces may include one or more modules for executing these various capabilities. In one embodiment, the system can further include a maintenance module to assist in monitoring maintenance of the carrier's vehicle. In this embodiment, the communication interface can be in communication with an onboard diagnostic computer that monitors and transfer information regarding the status of the vehicle such as, for example, the number of hours of operation, or any status messages generated by sensors on the vehicle or by a engine control computer module for the vehicle. This information can be used by the central computer for scheduling routine preventive maintenance of the vehicle or for dispatching a service call.

Additionally, the communication interface can also include a human resources module for collecting and monitoring information for use by the human resources department of the freight carrier. The human resources module may, for example, require the vehicle operator to log in each time he begins operating the vehicle. In this way, the system can track information about which driver handled each piece of freight in a shipment, driver operating time for the vehicle, number of freight pieces handled, or other information. The collected information can be transmitted to the central computer for use in generating payroll information, work assignments, or for historical purposes. Additionally, the human resources can include a module for monitoring the driving time and maintaining a hourly log for the vehicle's operator.

The system and method of the present invention are designed to be integrated into the existing freight tracking and invoicing infrastructure of a freight carrier, and supplements the carrier's existing computerized invoicing software. The following description of a typical freight carrier's freight tracking and invoicing functions should provide contextual understanding of how the present invention is implemented and used.

A freight shipment cycle begins when the freight carrier receives a request from a shipper, by telephone or internet, for a freight pickup. The freight carrier will assign a shipment number (pro number) to this shipment, and will instruct a vehicle operator to pick up the shipment. Alternatively, a pro number can be generated by the vehicle operator when he is at the shipper's facility. Typically, the following minimum information is obtained: consignee name and address, stated weight of the shipment and payment information. This information may be provided by telephone, or more typically on a bill of lading prepared by the shipper and given to the truck driver for the freight carrier. Upon receipt of this information, the vehicle operator will input the information into the data entry device. Typically, a shipment number (pro number) is also assigned to the shipment of freight and input into the data entry device. The inputted information is communicated to the encoding device, which then encodes the information on a label. The vehicle operator then attaches the encoded label to the piece of freight. If the shipment of freight comprises two or more pieces, a separate label can be encoded for each piece. The freight shipment is loaded onto the carrier's vehicle and transported to the carrier's terminal.

In one embodiment, the identifying information can be transmitted from the data entry device to a remote receiving facility, such as the carrier's freight terminal or central office. The thus transmitted identifying information can be stored in a database. As noted above, the carrier's scheduler can also use the transmitted identifying information in preparing a route/delivery schedule from the carrier's terminal facility to its final destination. The carrier scheduler can then associate the prepared schedule with the identification code or number in a database or central computer. As a result, when the carrier's vehicle returns from the shipper's facility, an operator of the lift truck can determine which truck the shipment of freight is to be loaded onto by scanning the encoded label with a reader that is in communication with the database or central computer. The recalled schedule can then be provided to the lift truck operator, for example, with a visual display on the lift truck or the reader.

The freight can then be loaded on the appropriate truck and shipped to its final destination. The presence of the encoded label permits the identifying information for the shipment of freight to be recalled without having to access an external database or computer. As a result, the information can be recalled at any point along its shipping route and is not limited to any specific location or facility.

Additionally, the freight carrier's accounting system has all the information needed to generate an invoice for the shipment. The conventional system will generate an invoice at a suitable time using, as a basis for the shipping charges, the stated weight provided by the shipper. The present invention integrates with the existing accounting and invoicing system and provides the capability to update the data record for each shipment or pro number with a real-time actual weight for the shipment. The invoicing module in the central computer uses the thus-captured identifying information and real-time actual weight data to generate customer invoices. The invoices are based upon the actual weight for each piece of freight shipped, rather can an estimate of the shipment weight. The freight carrier's standard accounting software can utilize the information to generate the customer invoices using customer information stored in a database.

Information maintained by the system of the present invention can be made available to authorized users through conventional hard-wired networks, wireless networks, virtual private networks, through web access, or other suitable networking methods.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for tracking freight comprising:
a vehicle for transporting a piece of freight;
a data entry device accessible to an operator of the vehicle for receiving input of identifying information associated with a piece of freight which is received for shipment;
a label capable of being affixed to the piece of freight; and
an encoding device operable for receiving identifying information for a piece of freight which has been input to the data entry device and encoding the identifying information onto said label.

2. The system of claim 1, wherein the encoding device and data entry device are integrated in a single handheld device.

3. The system of claim 1, additionally including a wireless transmitter operable for transmitting the identifying information for a piece of freight to a remote receiving site, and a database communicatively connected to the remote receiving site for receiving and storing the identifying information.

4. The system of claim 3, wherein the wireless transmitter is capable of wireless communications via a wide area network, local area network, cellular network, or a combination thereof.

5. The system of claim 3, wherein the encoding device, the data entry device, and the wireless transmitter are integrated in a single handheld device.

6. The system of claim 1, wherein the label comprises a 2-D bar code, RFID tag, or a combination thereof.

7. The system of claim 1, wherein the identifying information comprises an identification code or number and at least one additional data field selected from the group consisting of: a point of origin; a final destination; weight of the piece of freight, special handling instructions for the piece of freight; classification for the piece of freight; number of items associated with the shipment; estimated value of the piece of freight; and digital image of the piece of freight.

8. The system of claim 7, wherein the encoding device includes a printer operable for writing the identifying information as a 2-D bar code.

9. The system of claim 7, wherein the label comprises a write once, read many RFID tag, and the encoding device includes a radio frequency transmitter operable for writing the identifying information to the RFID tag.

10. The system of claim 1, including a hand-held wireless transmitter-receiver operable for transmitting to and receiving from a remote site, said data entry device being located on the hand-held wireless transmitter-receiver, and said handheld-held wireless transmitter-receiver including a memory device, said memory device including a storage location for receiving and storing the identifying information input from the data entry device, and stored executable instructions for transmitting the stored identifying information for a piece of freight to the remote receiving site via said transmitter.

11. The system of claim 10, wherein said hand-held wireless transmitter-receiver also includes a GPS module, and including stored executable instructions in said memory device for also transmitting GPS location information to the remote receiving site.

12. The system of claim 10, wherein said remote site is a central freight terminal, and including a display device on said hand-held wireless transmitter-receiver, and means for receiving information transmitted from the central freight terminal and displaying the same on the display device.

13. A system for tracking freight comprising:
a vehicle for transporting a piece of freight;
a hand-held device accessible to an operator of the vehicle, the hand-held device including a memory for receiving and storing identifying information associated with a piece of freight which is received for shipment, the identifying information including an identification code or number and at least one additional data field selected from the group consisting of: a point of origin; a final destination; weight of the piece of freight, special handling instructions for the piece of freight; classification for the piece of freight; number of items associated with the shipment; estimated value of the piece of freight; and digital image of the piece of freight, and the hand-held device also including a wireless transmitter operable for transmitting the identifying information for the piece of freight to a remote receiving site;
a label capable of being affixed to the piece of freight; and
an encoding device operable for receiving identifying information for a piece of freight from said memory and encoding the identifying information onto said label.

14. The system of claim 13, wherein the encoding device includes a printer operable for writing the identifying information as a 2-D bar code.

15. The system of claim 13, wherein the label comprises a write once, read many RFID tag, and the encoding device includes a radio frequency transmitter operable for writing the identifying information to the RFID tag.

16. The system of claim 13, wherein the hand-held device also includes a GPS module cooperating with said wireless transmitter for also transmitting GPS location information to the remote receiving site.

17. The system of claim 13, wherein the hand-held device also includes a display device for communicating information to the operator of the vehicle, and a wireless receiver for receiving information from a remote transmitting site.

18. The system of claim 17, including an input device at a central freight terminal communicatively connected to said remote transmitting site, a dispatch module communicating with said input device for receiving information about freight shipments requiring pick-up and for transmitting dispatch information to said hand-held device, and wherein said hand-held device includes means for receiving the dispatch information and displaying the same to the operator of the vehicle via said display device.

19. A method for tracking freight comprising:
receiving a piece of freight from a shipper at a point of origin;
inputting identifying information associated with the piece of freight into a data entry device at the point of origin;
communicating the identifying information to an encoding device;
encoding said identifying information onto a label;
attaching said label to said piece of freight; and
transporting said piece of freight to a second location.

20. The method of claim 19, additionally including wirelessly transmitting the identifying information to a remote receiving site, and storing the identifying information in a database.

21. The method of claim 20, wherein the step of wirelessly transmitting the identifying information comprises transmitting via a wide area network, local area network, cellular network, or a combination thereof.

22. The method of claim 19, wherein the step of encoding the identifying information onto a label comprises printing a 2-D bar code

23. The method of claim 19, wherein the step of encoding the identifying information comprises writing the identifying information to a write once, read many RFID.

24. The method of claim 19, wherein the step of encoding said identifying information onto a label comprises encoding the label with an identification code or number and at least one additional data field selected from the group consisting of: a point of origin; a final destination; weight of the piece of freight, special handling instructions for the piece of freight; classification for the piece of freight; number of items associated with the shipment; estimated value of the piece of freight; and digital image of the piece of freight.

25. The method according to claim 24, further comprising the step of scanning the label at said remote location to recall the identifying information for said piece of freight directly from the identifying information encoded on the label.

26. The method according to claim 24, wherein the data entry device includes a digital camera for taking a digital image of the piece of freight.

27. The method according to claim 24, further comprising the steps of:
scanning the label at the second location to recall the identifying information for said piece of freight directly from the identifying information encoded on the label;
weighing the piece of freight to obtain weight of the piece of freight; and
transmitting the thus obtained weight data to the remote receiving site.

28. A method for tracking freight comprising:
receiving a piece of freight from a shipper at a point of origin;
inputting into a hand-held device at the point of origin identifying information associated with the piece of freight, the identifying information including an identification code or number and at least one additional data field selected from the group consisting of: a point of origin; a final destination; weight of the piece of freight, special handling instructions for the piece of freight; classification for the piece of freight; number of items associated with the shipment; estimated value of the piece of freight; and digital image of the piece of freight,
communicating the identifying information to an encoding device;
encoding said identifying information onto a label;
attaching said label to said piece of freight;
wirelessly transmitting the identifying information for the piece of freight to a remote receiving site; and
transporting said piece of freight to a second location.

29. The method of claim 28, wherein the step of encoding the identifying information onto a label comprises writing the identifying information as a 2-D bar code.

30. The method of claim 28, wherein the step of encoding the identifying information onto a label comprises the label comprises writing the identifying information to a write once, read many RFID tag.

31. The method of claim 28, including receiving dispatch information transmitted from a central freight terminal about freight shipments requiring pick-up and displaying the same to the operator of the vehicle via a display device on the hand-held device.
